(19) United States
(12) Patent Application Publication
(10) Pub. No.: US 2023/0191325 A1
(43) Pub. Date: Jun. 22, 2023

(54) A PROCESS FOR THE REMOVAL OF NOX AND DINITROGEN OXIDE IN PROCESS OFF-GAS

(71) Applicant: Topsoe A/S, Kgs. Lyngby (DK)

(72) Inventor: Janus Emil Münster-Swendsen, Espergærde (DK)

(21) Appl. No.: 17/914,874

(22) PCT Filed: Mar. 29, 2021
(86) PCT No.: PCT/EP2021/058101

§ 371 Date: Sep. 27, 2022

(30) Foreign Application Priority Data
Apr. 1, 2020 (DK) PA 2020 00371

(51) Int. Cl. B01D 53/86; B01J 23/00; B01J 23/78; B01J 29/76; B01J 23/22; B01J 35/04

(52) U.S. Cl. CPC B01D 53/869; B01D 53/8628; B01D 53/8634; B01J 23/005; B01J 23/22; B01J 23/78; B01J 29/7615; B01J 35/04; B01D 2255/202; B01D 2255/502; B01D 2255/902; B01D 2255/904; B01D 2255/2022; B01D 2255/2027; B01D 2255/20707; B01D 2255/20723; B01D 2255/20738; B01D 2255/20746

(57) ABSTRACT

Process for the removal of NOx (NO, NO2) and nitrous oxide (N2O) contained in a process off-gas comprising the steps of (a) adding an amount of a NOx reducing agent into the process off-gas;(b) in a first stage passing the process off-gas admixed with the reducing agent through a catalyst active in selective catalytic reduction of NOx with the reducing agent and providing an effluent gas comprising the nitrous oxide and residual amounts of reducing agent; and(c) in a second stage passing the effluent gas through a catalyst comprising a cobalt compound and being active in decomposition of nitrous oxide and oxidation of the residual amounts of the reducing agent.

The present invention relates to a process for the combined removal of NOx (NO and NO₂) and nitrous oxide (dinitrogen oxide, N₂O) in process off-gas.

NOx is a known pollutant, contributing to particulate formation and ozone. N₂O is a powerful greenhouse gas and is therefore associated with a cost in areas with a CO2 market. Emissions of both substances is typically regulated. Thus, the removal of NOx and N₂O needs to be performed as cost efficiently as possible.

Nitric acid production is an industry with known NOx and N₂O emissions. Additionally, nitric acid production also has very strict requirements to ammonia (NH₃) slip from NOx and N₂O removal due to the risks of ammonium nitrate forming in cold spots downstream the catalytic reactor. Slip requirement is typically 5 ppm or down to 3 or even 2 ppm.

Nitric Acid (HNO₃) is mainly used for manufacturing of fertilizer and explosives.

It is typically produced via the Ostwald process, after the German chemist Wilhelm Ostwald. In this process ammonia (NH3) is oxidized to nitric oxide (NO). However, the oxidation of NH₃ to NO is not 100% selective, meaning that a certain amount of dinitrogen oxide (nitrous oxide, N₂O) is also formed together with the desired NO. The nitric oxide is oxidized to nitrogen dioxide (NO₂) which is absorbed in water to form nitric acid. The process is pressurized and the off gas contains NOx and N₂O but is otherwise very clean.

The term “NOx” as used herein refers to nitrogen oxides other than nitrous oxide.

Depending on the oxidation conditions, i.e. prevailing pressure, temperature and inflow velocity to the NH₃ combustion and also type and state of ageing of the catalyst, about 4-15 kg of N₂O will typically be formed per metric ton of HNO₃. This results in typical N₂O concentrations of about 500-2000 ppm by volume in the process off-gas.

The N₂O formed in the oxidation of ammonia is not absorbed during absorption of nitrogen dioxide (NO₂) in water to form nitric acid. Further, it is not viable to convert all NOx into nitric acid. Thus, NOx and N₂O emit with the HNO₃ production process off-gas.

NOx is typically removed by the known selective catalytic reduction (SCR) process through reaction with ammonia as reducing agent to nitrogen and water.

Suitable catalysts for use in the SCR are known in the art and comprise typically vanadium oxide and titanium oxide. Most typically vanadium pentoxide supported on titanium dioxide. Such catalyst potentially also comprises molybdenum oxide or tungsten oxide

Since DeNOx stages installed downstream the absorption tower for reducing the residual content of NOx generally do not bring about a reduction in the N₂O content, the N₂O finally emits into the atmosphere.

Since N₂O is a potent greenhouse gas with some 300 times the effect of CO₂, and nitric acid plants now represent the single largest industrial process source of the former gas, N₂O makes a considerable contribution to decomposing ozone in the stratosphere and to the greenhouse effect. For environmental protection reasons there is therefore an increasing need for technical solutions to the problem of reducing N₂O emissions together with NOx emission during nitric acid production and other industrial processes.

The known possible methods of lowering N₂O emissions from HNO₃ plants can be categorized broadly into three groups:

Primary solution: N₂O is prevented from being formed in the first place. This requires modifications to the platinum gauzes to reduce N₂O formation. Alternative materials can be employed as the ammonia oxidation catalyst. For example, metal oxides, which do not generate significant amounts of N₂O by-product, but suffers from being less selective for the production of NO.

Secondary solution: N₂O, once formed, is removed anywhere between the outlet of the ammonia oxidation gauzes and the inlet of the absorption tower. The position of choice for secondary methods is directly after the gauzes where the temperature is at its highest. Most technologies employ a catalyst in the form of pellets, either loose or enclosed in cages made of heat resistant wire, while some use honeycombs.

Tertiary solution: N₂O is removed from the process off-gas downstream the absorption tower, either by catalytic decomposition to N₂ and O₂ or by catalytic reduction with a chemical reducing agent. The optimum position for locating a tertiary abatement step is typically at the hottest position downstream the absorption tower, immediately upstream of an expansion turbine. Known solution are using a pellet catalyst comprising an iron zeolite arranged with radial or horizontal flow through the catalyst beds to keep pressure drop to an acceptable level. This typically requires large reactors.

The known tertiary catalyst units typically employ two beds: A first bed for removing bulk N₂O, then addition of a reducing agent, and a second bed for removing NOx and the remaining N₂O. The result is a very large and complex reactor with two radial flow beds and internal dosage of reducing agent. With the present invention, removal of NOx and N₂O is achieved with a simpler and smaller reactor, thereby reducing overall complexity and costs.

Known tertiary catalyst units can also have only one bed with combined NOx and N₂O removal, where the reducing agent is added upstream the tertiary reactor. Sufficient mixing is achieved by use of known methods of stationary mixers or simply by sufficient mixing length.

In order to obtain low emission of N₂O and low slip of NH₃, a highly effective mixing of the NH₃ in the gas is required along with a larger catalyst volume to allow the reactions to take place.

In the reactors with radial or horizontal flow it is not possible to make a bottom layer with a different type of catalyst such as in the present invention. In the reactors with radial or horizontal flow it would have to be a separate bed, adding significant size and cost to the reactor.

Typically, N₂O is removed in nitric acid tail gas by means catalyst pellets comprising an iron zeolite.

Slip of ammonia reductant poses a security risk in nitric acid production, due to potential formation of ammonium nitrate in cold spots downstream or in the stack. Therefore, requirements to ammonia slip are typically very strict.

Processes using a hydrocarbon as reducing agent have typically lower activity and will therefore experience a significant slip of the used hydrocarbon along with partial combustion products such as CO. Methane frequently used in such processes, as reducing agent is in itself a potent greenhouse gas, thereby to some extend offsetting the N₂O emission reduction. Carbon monoxide is a toxic gas and emissions are therefore unwanted.

In order to obtain low emission of N₂O and a low slip of reducing agent, highly effective mixing of the reducing agent in the gas is required along with a larger catalyst volume to allow the reactions to take place.

When using ammonia as reducing agent, then in order for the N₂O decomposition reaction to be effective and result in a slip below 5 ppm ammonia or lower, a significant additional volume of catalyst is needed in those reactors.

We have found that catalysts comprising cobalt are very effective in the decomposition of N₂O and oxidation of ammonia.

These catalysts provide the following advantages.

In typical SCR installations for the removal of NOx, the ammonia is added just below the stoichiometric amount, especially in applications where a low ammonia slip is important, such as nitric acid production.

Because the catalysts comprising cobalt has high oxidation efficiency of the reducing agent employed in the DeNOx SCR process, the reducing agent can be added in a first stage into the process gas in slightly higher amounts than stoichiometric requested by the content of NOx in the process gas.

Adding the reducing agent in higher amounts than stoichiometric requested by the content of NOx in the process gas, means that the catalyst volume required for NOx removal can be reduced.

Higher amounts of reducing agent result in a substantially full removal of NOx.

Based on the above advantage, a further advantage is that extensive mixing of the reducing agent with the process gas can be less extensive. When the slip of reducing agent, such as ammonia, must be very low and the removal rate of NOx must be high, the reducing agent must be mixed very thoroughly into the gas in order to avoid regions with too little or too much reducing agent. Too little result in lower removal of NOx and too much result in a slip of reducing agent. Such very good mixing requires expensive static mixers which also increase the pressure drop of the process.

When the catalyst comprising a cobalt compound in the second stage is active for oxidation of the reducing agent, it is much less critical to have regions in the first catalyst bed with too much reducing agent. This means that the reducing agent does not have to mixed as well into the process gas. Less efficient mixing can require slightly higher dosing of reducing agent to reach same level of NOx removal in the first stage. However, as any slip of reducing agent from the first stage is oxidized in the second stage, this is not causing a problem.

Further, compared to processes which need reducing agents, such as NH₃ or hydrocarbons, for removal of the N₂O in the gas, especially at lower temperatures, the present invention offers an advantage with lower NH3 consumption and/or no hydrocarbon consumption. In the present invention, some N₂O can be removed using NH₃ in the first stage, but this is only a small fraction of the total N₂O. Especially at lower temperatures, most removal of N₂O will take place in the second stage, where no reducing agent is needed for the catalyst comprising cobalt to remove N₂O. The lower consumption of reducing agent results in operational cost savings.

Thus, the present invention provides an improved process for the removal of NOx (NO, NO₂) and nitrous oxide (N₂O) contained in a process off-gas, comprising the steps of
(a) adding an amount of a NOx reducing agent into the process off-gas;
(b) in a first stage passing the process off-gas admixed with the reducing agent through a catalyst active in selective catalytic reduction of NOx with the reducing agent and providing an effluent gas comprising the nitrous oxide and residual amounts of reducing agent; and
(c) in a second stage passing the effluent gas through a catalyst comprising a cobalt compound and being active in decomposition of nitrous oxide and oxidation of the residual amounts of the reducing agent.

Preferred reducing agents for use in the invention comprise ammonia or precursors thereof.

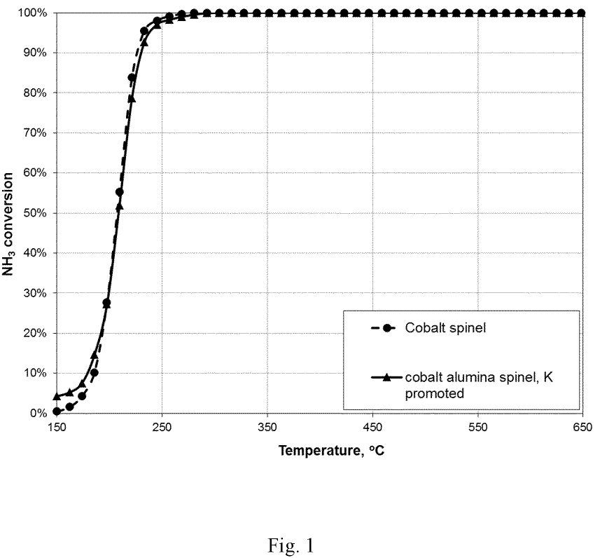

A high efficiency in the oxidation ammonia in contact with the cobalt compound comprising catalyst is obtained when cobalt compound is cobalt spinel as shown in the attached drawings, wherein FIG. 1 shows ammonia conversion at temperatures between 150 and 650° C. of cobalt spinel and cobalt-alumina spinel promoted with potassium.

Thus, in an embodiment of the invention the cobalt compound comprises cobalt spinel.

In an embodiment the cobalt compound is promoted with alkali compounds such as sodium (Na), potassium (K) and/or cesium (Cs)

In an embodiment, the cobalt compound comprising catalyst contains additionally metal(s) such as Zn, Cu, Ni, Fe, Mn, V, Al and/or Ti.

The term “removal of NOx” and “removal of nitrous oxide (N₂O)” should be understood as substantially reducing the amounts of NOx and N₂O, even if minor amounts of NOx and N₂O can still be contained in the process off-gas.

Preferably, a part of the N₂O can be removed in the first stage of the process according to the invention.

In an embodiment of the invention, the catalyst active in selective catalytic reduction of NOx, is also active in removal of nitrous oxide using the same reducing agent.

Thereby, the first stage can be operated with a substantially full removal of NOx along with substantially no slip (less than 10ppm) of the reducing agent as this reducing agent can be consumed by reactions with nitrous oxide also. This further means that there are even less requirements to the mixing of the reducing agent as stoichiometric excess for NOx reactions in part of the catalytic bed can react with nitrous oxide. In such case slightly higher dosing of reducing agent is needed. Such reducing agent can be ammonia (NH₃) or precursors thereof.

In an embodiment of the invention, less than 50% of the N₂O is removed in the first stage.

In an embodiment of the invention, the catalyst active in selective catalytic reduction of NOx, comprises a metal exchanged zeolite, in which the metal comprises Fe, Co, Ni, Cu, Mn, Zn or Pd or mixtures thereof.

Preferably, the metal exchanged zeolite is selected from the group consisting of MFI, BEA, FER, MOR, FAU, CHA, AEI, ERI and/or LTA.

The most preferred metal exchanged zeolite is Fe-BEA.

In an embodiment, the catalyst active in selective catalytic reduction of NOx is selected from oxides of V, Cu, Mn Pd, Pt or mixtures thereof.

In another embodiment, the catalyst active in selective catalytic reduction of NOx and/or the catalyst comprising a cobalt compound is monolithic shaped.

The term “monolithic shaped catalyst” should be understood as a monolithic or honeycomb shape containing or coated with catalytic active material.

The monolithic shaped catalyst is preferably arranged orderly layered in one or more layers inside reactor(s).

The monolithic shaped catalysts enable an axial flow reactor design, while at the same time providing a low pressure drop, compared to the radial flow reactor design with pellet catalysts.

In another preferred embodiment, the first and/or second monolithic shaped catalyst is arranged inside the reactor in more than one stacked layer.

The invention is further discussed in the following detailed description of a specific embodiment thereof.

In an embodiment, the addition of reducing agent is operated to give the lowest total NOx concentration in the second stage as NOx is an inhibitor to the N₂O reactions. As the selectivity towards NOx from the NH3 oxidation in the second stage is lower than 100%, the optimal NH3 dosing is just above stoichiometric. The degree of mixing of the ammonia in the gas before the catalytic step also plays a role in the optimal NH3 dosing.

A process according an embodiment of the invention is performed in a nitric acid process downstream of an absorption tower, after reheating of the process off-gas but before an expander. Ammonia is injected and mixed into the off-gas. The off-gas admixed with the ammonia enters in a first stage a reactor with a first stage with a catalyst comprising titanium dioxide, vanadium oxide and tungsten oxide installed. In the first stage NOx react with the ammonia according to the well-known SCR reactions. The catalyst volume in the first stage and the amount of ammonia addition is adjusted such that the content of NOx in the off-gas will be significantly reduced to NOx slip of about 5 and 10 ppm by volume and an ammonia slip of between 5 and 10 ppm by volume in the effluent gas from the first stage.

The effluent gas enters subsequently the second stage a catalyst comprising cobalt spinel promoted with potassium.

In the second stage the NH₃ is oxidized to a combination of Nitrogen (N₂), NOx and N₂O. It is preferable that the catalyst comprising a cobalt compound that has high selectivity towards inert nitrogen or alternatively selectivity towards N₂O that can be removed again by the catalyst in the second stage. Selectivity towards NOx is unwanted as NOx inhibits the N₂O decomposition reactions.

In the second stage the N₂O is by contact with the promoted cobalt spinel decomposed according to the reaction:

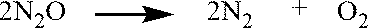

NH₃ is oxidized to a combination of Nitrogen (N₂), NOx and N₂O. N₂O formed by the oxidation of NH₃ is then decomposed by contact with promoted cobalt spinel catalyst.

Any NOx being formed by the oxidation of NH3 in the second stage is not an emission problem, as the NOX emission from the first stage is very low and the NH3 slip from the first stage into the second stage is still kept at a level so low, that reduced selectivity would still only lead to a limited NOx emission. The NOx will inhibit the N₂O decomposition reactions of the promoted cobalt spinel catalyst, thereby reducing the activity. Therefore, NOx formation in the second stage must be kept at a minimum.

Temperatures are typically in the range of 300-550° C. Pressure is typically in the range of 4-12 bar g, but can be both higher and lower. A higher pressure increases activity of NOx conversion in the first stage and it increases NH3 and N₂O conversion in the second stage.

As already mentioned hereinbefore by subsequently removing most of the ammonia slip from the first stage, the requirements to the mixing of ammonia with the process off-gas are significantly reduced.

A process according an embodiment of the invention is performed in a nitric acid process downstream of an absorption tower, after reheating of the process off-gas but before an expander. Ammonia is injected and mixed into the off-gas. The off-gas admixed with the ammonia enters in a first stage a reactor with a first stage with a catalyst comprising Fe-BEA zeolite installed. In the first stage NOx react with the ammonia according to the well-known SCR reactions. But the iron zeolite catalyst is also active for decomposing N₂O using NH₃, according to the reaction:

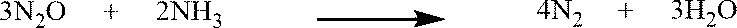

This reaction is slower than the SCR reactions removing the NOx. But it means that more NH₃ can be dosed than what is needed for the NOx reactions and that this excess NH3 will then be used to decompose N₂O. The catalyst volume in the first stage and the amount of ammonia dosing is adjusted such that the gas coming from the first stage is essentially free from NOx and with a low NH3 slip, below 20 ppm or 10 ppm or 5 ppm by volume in the effluent gas from the first stage.

The optimal choice between a catalyst active for N₂O reactions in the first bed, catalyst volumes and NH3 addition is governed by the initial concentration of NOx and N₂O, the gas temperature and pressure, the injection system for NH₃ and the required conversions of NOx and N₂O. Water (H₂O) and oxygen (O₂) concentration will also affect the optimal choice as the different reactions has different sensitivity towards H₂O and O₂.

In an embodiment, the monolithic catalyst active in selective catalytic reduction of NOx in the first stage is stacked directly on top on a monolithic catalyst comprising a cobalt compound in the second stage. Thereby a simple axial flow reactor can be utilized with only one man hole access and one support grid for the stacked catalysts and the pressure drop of the reactor is still low.

1. Process for the removal of NOx (NO, NO2) and nitrous oxide (N₂O) contained in a process off-gas comprising the steps of
(a) adding an amount of a NOx reducing agent into the process off-gas;
(b) in a first stage passing the process off-gas admixed with the reducing agent through a catalyst active in selective catalytic reduction of NOx with the reducing agent and providing an effluent gas comprising the nitrous oxide and residual amounts of reducing agent; and
(c) in a second stage, oxidizing residual amounts of reducing agent and decomposing nitrous oxide by passing the gas through a catalyst comprising a cobalt compound.

2. Process of claim 1, wherein the reducing agent comprises ammonia or precursors thereof.

3. Process of claim 1, wherein the cobalt compound is cobalt spinel.

4. Process of claim 1, wherein the catalyst comprising a cobalt compound is promoted with Sodium (Na), potassium (K) and/or cesium (Cs).

5. Process of claim 1, wherein the catalyst comprising a cobalt compound, contains Zn, Cu, Ni, Fe, Mn, V, Al and/or Ti.

6. Process of claim 1, wherein a part of the nitrous oxide is decomposed in step (b).

7. Process of claim 1, wherein the catalyst active in selective catalytic reduction of NOx comprises a metal exchanged zeolite, in which the metal comprises Fe, Co, Ni, Cu, Mn, Zn or Pd or mixtures thereof.

8. Process of claim 7, wherein the metal exchanged zeolite is selected from the group consisting of MFI, BEA, FER, MOR, FAU, CHA, AEI, ERI and/or LTA.

9. Process of claim 7, wherein the metal exchanged zeolite is Fe-BEA.

10. Process of claim 1, wherein the catalyst active in selective catalytic reduction of NOx comprises vanadium oxide and titanium oxide.

11. Process of claim 1, wherein the catalyst active in selective catalytic reduction of NOx and/or the catalyst comprising a cobalt compound is monolithic shaped.

12. Process of claim 11, wherein the catalyst active in selective catalytic reduction of NOx and/or the catalyst comprising a cobalt compound are arranged in more than one stacked layer.
